(19) United States
(12) Patent Application Publication
(10) Pub. No.: US 2022/0363193 A1
(43) Pub. Date: Nov. 17, 2022

(54) VEHICLE EXTERNAL FEATURES

(71) Applicant: CANOO INC., Torrance, CA (US)

(72) Inventors: Sagar SHRIVASTAVA, San Pedro, CA (US); Giancarlo VIGANEGO, Torrance, CA (US); Megan MICHEL, Redondo Beach, CA (US); Charles SPENCER, Torrance, CA (US); Christoph KUTTNER, Ladera Ranch, CA (US); Richard KIM, Torrance, CA (US); Arthur Wilson CREWS, Long Beach, CA (US); Marco ELKENKAMP, Marina del Rey, CA (US); William Ice COCHRAN, Fullerton, CA (US)

(21) Appl. No.: 17/754,060

(22) PCT Filed: Sep. 21, 2020
(86) PCT No.: PCT/US2020/051805

§ 371 Date: Mar. 22, 2022

Related U.S. Application Data
(60) Provisional application No. 62/903,714, filed on Sep. 20, 2019.

(51) Int. Cl. B60R 1/12; B60R 1/06; B60J 1/02

(52) U.S. Cl. CPC B60R 1/1207; B60R 1/06; B60J 1/02; B60R 2001/1215; B62D 5/00

(57) ABSTRACT

Electric vehicles may have alternative positions for the drivetrain components such as the electric motor such as toward the rear of the vehicle. Thus, the hood/bonnet of the vehicle may be shortened and various features of the vehicle may be adjusted. For example, the driver may be seated at a position more towards the front of the vehicle. Various features of the vehicle may be adjusted to accommodate the driver's altered positioning. For example, the electric vehicle may include forward positioned side view minors that are disposed on an angled mounting arm such that the field of view of the mirrors meets regulatory requirements for vehicles. Additional embodiments incorporate a street view window disposed at the front portion of the vehicle and designed to allow increased forward visibility for the driver.

### CROSS-REFERENCED APPLICATIONS

This application claims priority to U.S. Provisional application No. 62/903,714 entitled “VEHICLE EXTERNAL FEATURES” and filed on Sep. 20, 2019, the disclosure of which is hereby incorporated by reference in its entirety.

### FIELD OF THE INVENTION

The present invention relates generally to features on the exterior of a vehicle that can improve the overall function, safety and/or appearance of the vehicle.

### BACKGROUND OF THE INVENTION

Automobile vehicles may generally be described in relation to a body or cabin, which are designed to enclose the passengers, and the various electrical, mechanical and structural systems, subsystems and components that allow the vehicle to operate. In addition to the functional features of a vehicle, many features can be implemented that improve the overall safety of the vehicle as well as serve as aesthetically pleasing components for passengers and passersby alike. Among all the systems and subsystems that are integrated into the automobile design, the safety of the occupants is foremost and many efforts have been made to ensure the passenger compartment is protected as much as possible during a crash event. Thus, features placed in and around the vehicle, even externally, should ultimately be aimed at maintaining the safety of the vehicle occupants.

Many vehicle manufacturers tend to follow traditional approaches to vehicle design and function. However, many interconnections between the body and the functional components of a vehicle can create a number of manufacturing and design inefficiencies. For example, a change in the motor may necessitate a change in the dimensions of the body. Similarly, altering the passenger compartment to include newly desired features, such as, for example, altering the vehicle profile or passenger seating position, may require a redesign of one or all of the functional systems of the vehicle. Additionally, any changes to the vehicle design can potentially affect the underlying safety of the vehicle for the occupants. Accordingly, many vehicle manufactures still follow traditional designs with respect to vehicles, despite the many advantages offered with the ever increasing use of electric vehicles. Such approaches can lead to missed opportunities within the vehicle market as well as lead to increased complexities in vehicle design to ensure occupant safety.

### SUMMARY OF THE INVENTION

Many embodiments are directed to an electric vehicle and the external features of such vehicle that improve the overall functionality and/or safety for the passengers as well as surrounding public.

Various embodiments are directed to a vehicle including:
an elongated side pillar extending vertically down a side front portion the vehicle; and
a side view mirror mounted on a bottom portion of the elongated side pillar,
wherein the side view mirror comprises:
   a mounting portion extending horizontally from the elongated side pillar, wherein the mounting portion extends at an angle oblique with respect to a vertical longitudinal median plane of the vehicle, and wherein the mounting portion extends in a direction that is towards the front of the vehicle;
   a mirror housing connected with the mounting portion, wherein the mirror housing extends in a direction towards the rear of the vehicle; and
   a mirror supported by the mirror housing.

In various other embodiments, the vehicle further includes a driver's seat positioned such that a driver has an eye box in the same vertical plane as a centroid of the mirror, and wherein an angle made by a line connecting the centroid of the mirror with a center of the eye box of the driver and another line extending through the center of the eye box of the driver and running parallel to the vertical longitudinal median plane of the vehicle is 55° or less.

In still various other embodiments, the mirror housing extends from the mounting portion in a direction oblique with respect to the vertical longitudinal median plane of the vehicle.

In still various other embodiments, the vertical longitudinal median plane is parallel to the extending direction of the vehicle.

In still various other embodiments, the mirror and the mirror housing extend in substantially the same direction.

In still various other embodiments, the mirror housing includes an indicator of current range of the vehicle.

In still various other embodiments, the indicator of current range of the vehicle comprises an indicator of charging state of the vehicle.

In still various other embodiments, the indicator of charging state includes a single indicator which changes colors based on various charging states of the vehicle.

In still various other embodiments, the single indicator indicates whether a charging port door is opened or closed.

In still various other embodiments, the single indicator indicates whether the charger is connected to the charging port.

In still various other embodiments, the single indicator is configured to indicate an intended turning direction.

Various embodiments are directed to a vehicle including:
a body having a front end, a rear end and a middle section running transverse along the front end and across the front of the vehicle;
a steering wheel column;
a windshield secured to the middle section and disposed at the front end such that a user can visibly see through the windshield over the middle section at the horizontal eye line position;
a street view glass secured to the middle section, disposed at the front end, and positioned below the windshield such that the street view glass is below a user's horizontal eye line position, wherein the street view glass is configured to allow a user to see directly in front of the vehicle with an unobstructed view, and wherein the unobstructed view lies over the steering wheel column and under the middle section.

In various other embodiments, the street view glass is secured to the body with one or more fasteners.

In still various other embodiments, the vehicle further includes a gasket between the street view glass and the body.

In still various other embodiments, the street view glass is connected to the middle portion through the gasket.

In still various other embodiments, the gasket comprises urethane.

In still various other embodiments, the windshield is connected to the middle portion through a windshield gasket.

In still various other embodiments, the windshield gasket comprises urethane.

In still various other embodiments, the vehicle further includes a subframe portion connected to the street view glass which is configured to absorb shock during a collision in order to keep the street view glass from breaking during a collision.

In still various other embodiments, the subframe portion is substantially rectangular.

In still various other embodiments, the vehicle further includes drivetrain components located beneath a bottom of the body. The drivetrain components may include an electric motor and a transmission.

In still various other embodiments, the steering wheel column is connected to steering components through drive-by-wire.

### DESCRIPTION OF THE DRAWINGS

The description will be more fully understood with reference to the following figures, which are presented as exemplary embodiments of the invention and should not be construed as a complete recitation of the scope of the invention, wherein:

FIG. 1A illustrates a perspective view of a vehicle in accordance with embodiments.

FIG. 1B illustrates a front view of a vehicle in accordance with embodiments.

FIGS. 2A and 2B illustrate various perspective views of a side view mirror in accordance with embodiments.

FIG. 3A illustrates a top down view of a side view mirror in accordance with embodiments.

FIG. 3B illustrates a marked up version of the top down view of the side view mirror depicted in FIG. 3A.

FIGS. 4A and 4B illustrate various marked up top down views of the side mirror depicted in FIG. 3A mounted on a vehicle.

FIGS. 5A to 5F illustrate various perspective views of a side view mirror in accordance with embodiments.

FIG. 6 illustrates various lighting states for an indicator light mounted on a side view mirror in accordance with embodiments.

FIGS. 7A and 7B illustrate various views of a side view mirror with a mounting mechanism in accordance with embodiments.

FIGS. 8A to 8E illustrate various embodiments of a side view mirror mounted on a vehicle.

FIGS. 9A and 9B illustrate various perspective views of a side view mirror in accordance with embodiments.

FIG. 10 illustrates a marked up top down view of the side view mirror depicted in FIGS. 9A and 9B.

FIG. 11 illustrates a schematic cross sectional view of a street view window mounted on a vehicle in accordance with embodiments.

FIGS. 12A and 12B illustrate various views from a cabin of a vehicle including a street view window in accordance with embodiments.

FIGS. 13A and 13B illustrate various views of a street view window mounted on a vehicle in accordance with embodiments.

FIG. 14 illustrates a perspective view of a street view window in accordance with embodiments.

FIG. 15A illustrates a perspective view of a street view window with gasket in accordance with embodiments.

FIG. 15B illustrates an exploded view of a street view window component in accordance with embodiments.

FIGS. 16A and 16B illustrates a front view of a street view window mounted in a vehicle in accordance with embodiments.

### DETAILED DESCRIPTION OF THE INVENTION

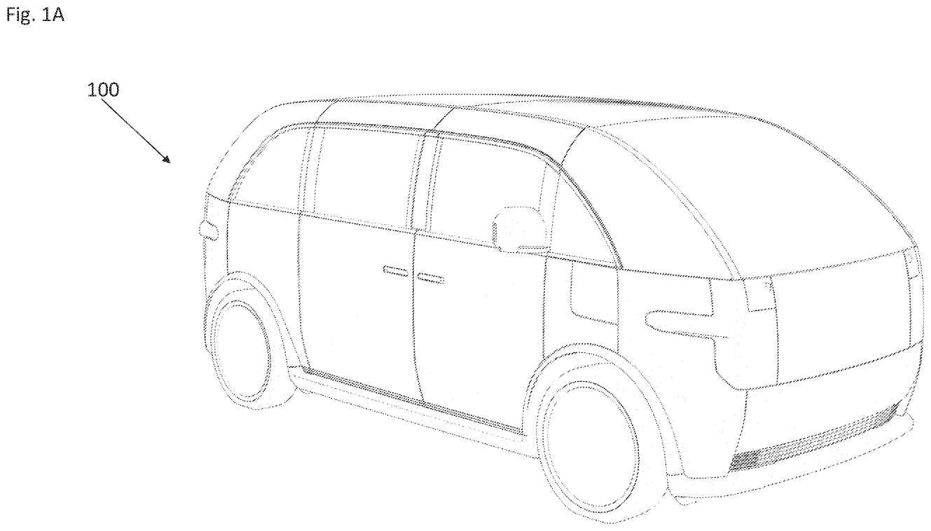

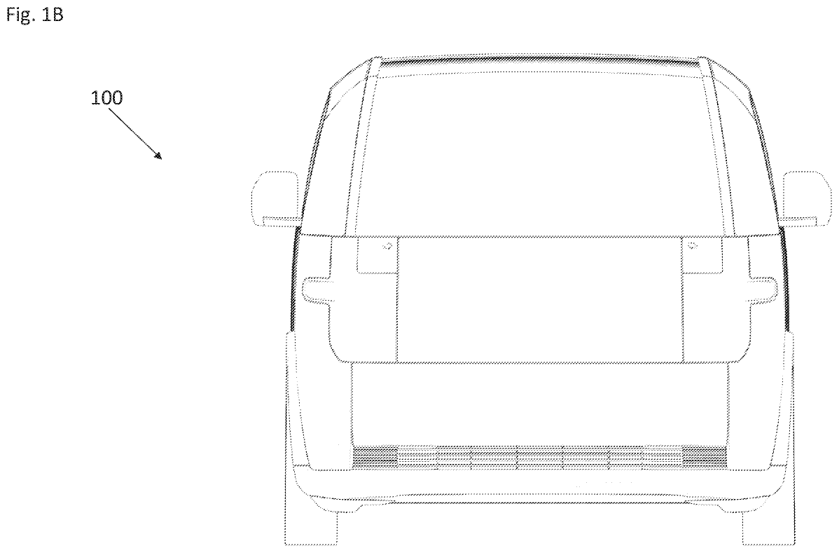

Turning now to the drawings, many embodiments include a vehicle with various external features that help to improve the overall safety of the vehicle and the driver. FIG. 1A illustrates a perspective view of an exemplary vehicle 100 such as a battery powered electric vehicle. FIG. 1B illustrates a front view of the exemplary vehicle 100. In battery powered electric vehicles, the electric motor may be positioned at the rear of the vehicle which may allow the hood/bonnet to be shortened. The drivetrain components (e.g. electric motor and transmission) may be positioned beneath the body of the vehicle which may limit the amount of components within the hood/bonnet region. As such various features of the vehicle may be adjusted in order to adapt the vehicle for such a configuration. For example, the driver may be positioned more towards the front of the vehicle since the drivetrain components do not occupy space within the hood/bonnet region. Further, particular embodiments of the vehicle position the driver more towards the center of the vehicle than typical.

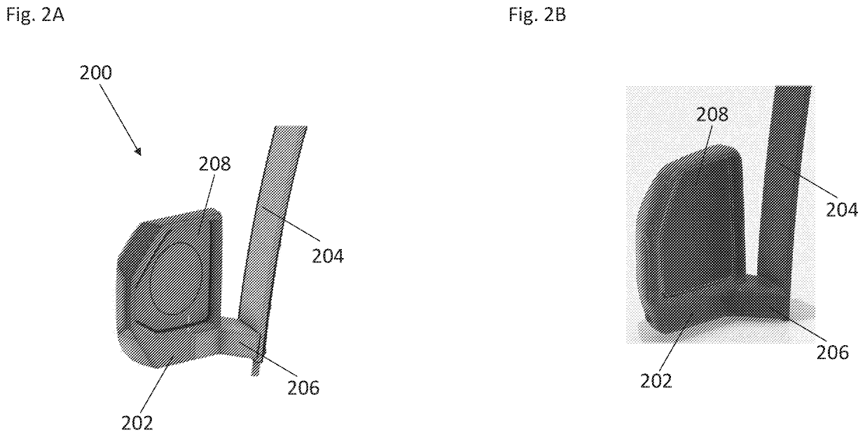

Many embodiments include a vehicle with side view mirrors that provide an adequate field of vision for the driver in accordance with specific regulations. Additionally, many embodiments include a forward positioned window or street view window in the front of the vehicle that is placed below the windshield. The features of the side view mirrors will be described in connection with FIGS. 2-10. The features of the street view window will be described in connection with FIGS. 11-16.

The development and manufacture of vehicles require compliance with many regulations within the various countries for which it is to be produced and used. For example, regulation ECE R46; paragraph 15.2.2.4 describes “The prescribed exterior mirror on the driver's side of the vehicle shall be so located that an angle of not more than 55° is formed between the vertical longitudinal median plane of the vehicle and the vertical plane passing through the center of the mirror and through the center of the straight line 65 mm long which joins the driver's two ocular points.” This paragraph is directly related to 15.2.4 Field of Vision. The field of vision cones should lay within the side view mirror glass and the side view mirror glass should be placed at such position that the center of the mirror (e.g. the centroid) lays within 55° of vertical line drawn from the center of the ocular points of the driver.

Based on various vehicle designs, this requirement set forth in the regulation, in accordance with many embodiments, may require the unique position of the side view mirror such that traditional placement may not work. As illustrated in FIGS. 2 to 4, many embodiments incorporate a novel placement and design of the side view mirrors. In accordance with many embodiments, the side view mirrors may be placed more towards the front of the vehicle than traditional vehicles. In part this is due to the untraditional vehicle design that many embodiments utilize to take advantage of the vast options within the context of electric vehicles. In particular, in the disclosed vehicle, the motor placement allows for the driver to sit further forward in the vehicle. The driver also may sit further towards the middle of the vehicle. The placement of the driver creates challenges in placement of the side view mirror in order to meet regulations.

FIGS. 2A and 2B illustrate various perspective views of an exemplary side mirror 200 with boomerang style arms. In accordance with many embodiments, a boomerang style arm may be used to position the mirrors such that the requirements of a 55° or less angle is met. The boomerang style arm includes a mounting portion 206 and a mirror housing 202. The mounting portion 206 attached to an elongated side pillar 204 which attaches to the vehicle with specifically designed mounting brackets and mounting points such that the mirror is fully supported and allows for the implementation of all adjustments within the specification above. Additionally, some embodiments may allow for the configuration of additional technological features which may be incorporated into the side view mirrors though the improved specialized mounting brackets. The mirror housing 202 supports a mirror 208.

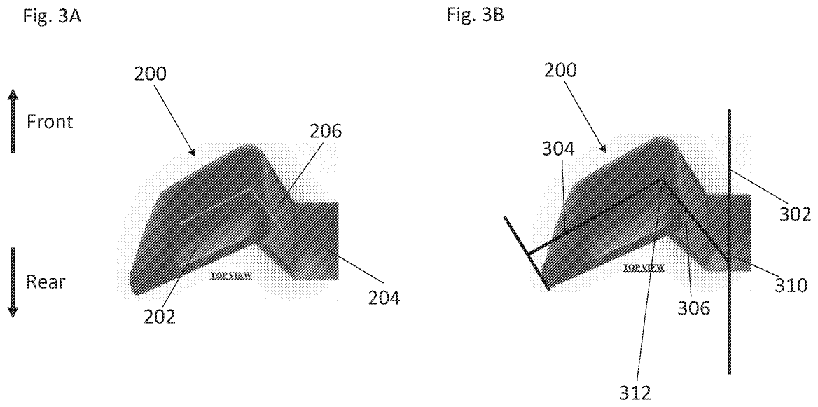

Typical the side view mirrors extend from the vehicle substantially horizontally or orthogonal to the extending direction of the vehicle. FIG. 3A illustrates a top down view of the exemplary side view mirror 200. As illustrated, the mounting portion 206 extends in a direction which approaches the front of the vehicle. Whereas, the mirror housing 202 extends in a direction which approaches the rear of the vehicle. Advantageously, this positions the side view mirror 200 at a position more towards the front of the vehicle which allows the side view mirror to meet regulations.

FIG. 3B illustrates a marked up version of FIG. 3A which includes illustrative lines which correspond to various extending directions of various components of the side mirror 200. The vertical longitudinal plane 302 runs parallel with the extending direction of the vehicle. The extending line 306 of the mounting portion 206 meets with the vertical longitudinal plane 302 to form an angle 310. In some embodiments, the angle 310 may be about 55° or more. Further the extending line 304 of the mirror housing 202 meets with the extending line 306 mounting portion 206 to form an angle 312. In some embodiments, the angle 312 may be about 125° or less.

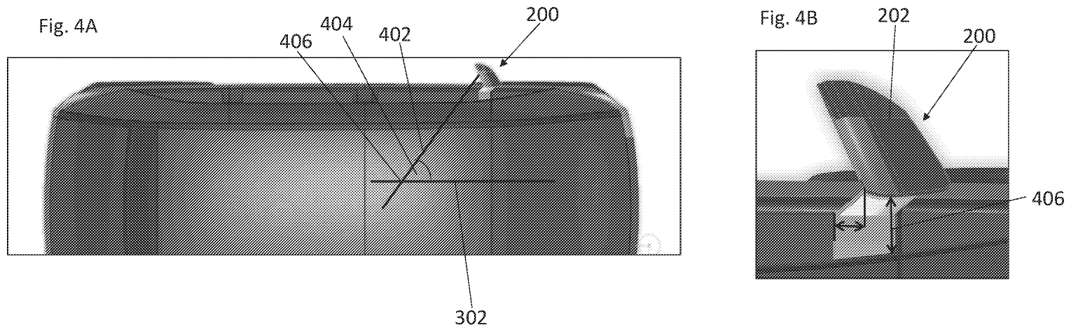

FIGS. 4A and 4B illustrate various top down views of the vehicle with the side mirror 200 mounted. A line of sight 402 exists between the driver of the vehicle and centroid of the side mirror 200. The line of sight 402 (e.g. the line connecting the centroid of the vehicle with the center of the ocular points of the driver) meets the vertical longitudinal plane 302 (e.g. a line extending through the center of the ocular points of the driver and running parallel to the extending direction of the vehicle) at the location where the driver is seated at angle 302. In some embodiments, the side mirror 200 may be mounted in such a manner that the angle 302 may be approximately less than or equal 54.5°.

As described above, regulations mandate that line of sight of the driver with the centroid of the side mirror make an angle with respect to the vertical longitudinal plane 302 of less than 55°. With particular vehicle configurations, these regulations may be difficult to meet. Specifically, when the vehicle is configured with the driver seated in a position that is more forward in the vehicle and inward towards the center of the vehicle. As illustrated in FIG. 4A, the dimensions described in connection with FIG. 3B for the side mirror 200 allow for the mirror to be situated such that the regulation is met. FIG. 4B further illustrates the interior edge of the mirror housing 202 may be a horizontal distance 406 away from the edge of the edge of the roof of the vehicle. In some embodiments, the horizontal distance 406 may be approximately equal to or more than 29 mm. In some embodiments, the horizontal distance 406 may be approximately equal to or more than 35 mm.

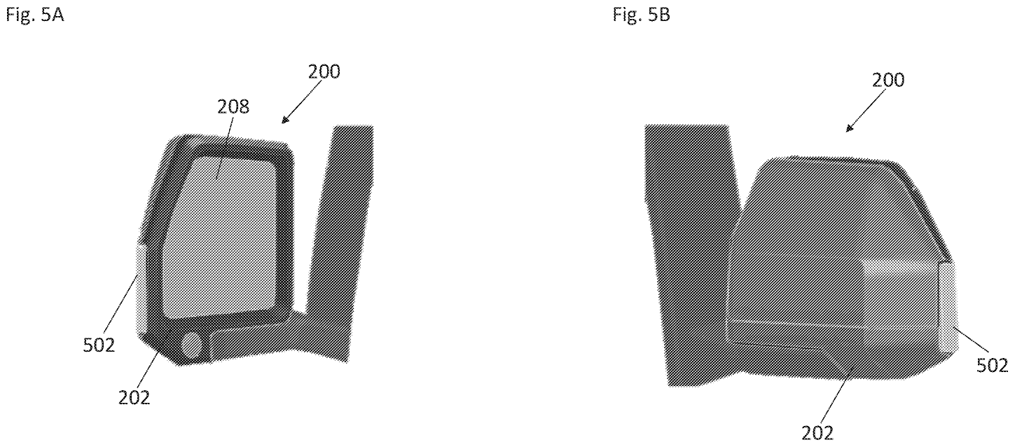

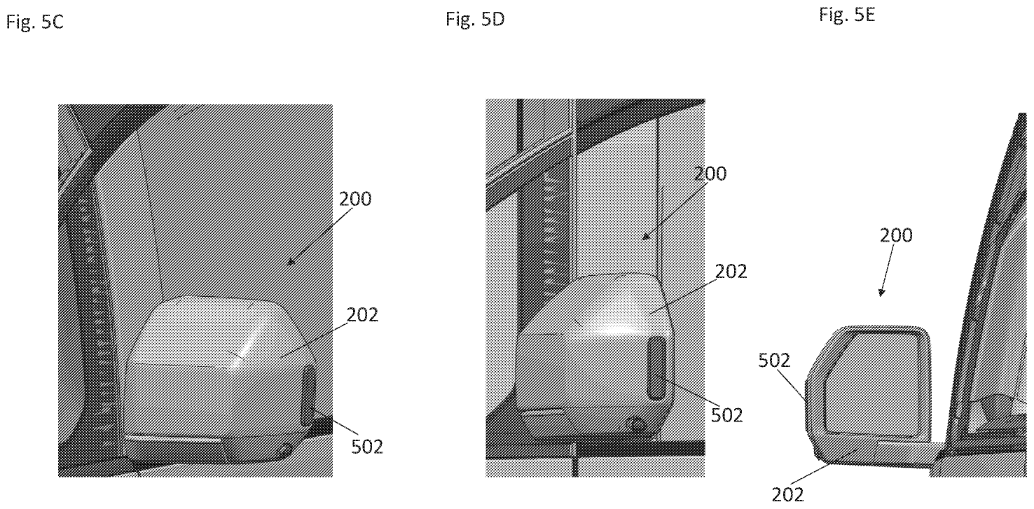

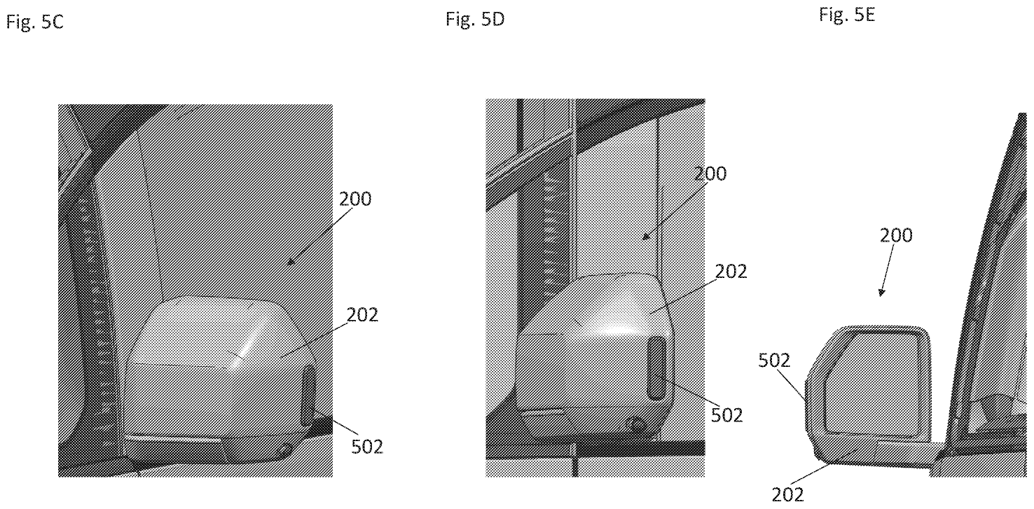

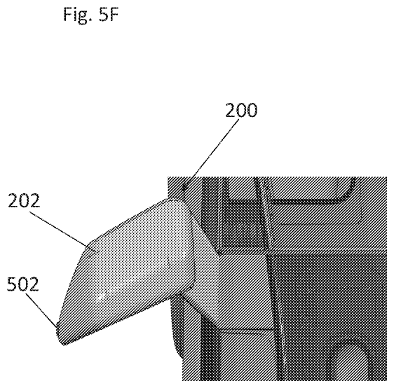

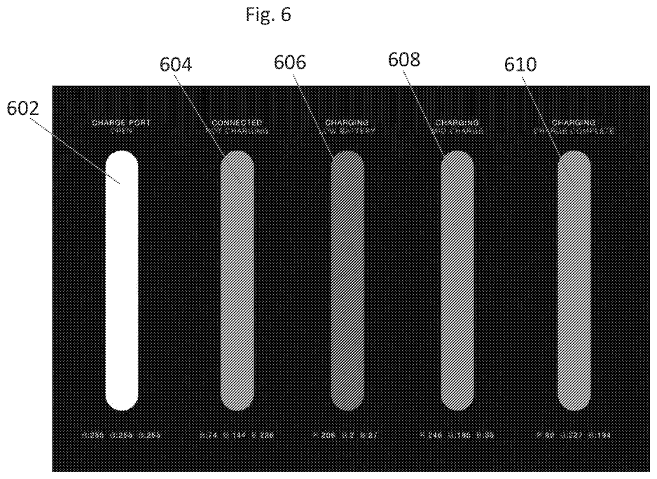

FIGS. 5A-5F illustrate various views of an implementation of a side mirror 200. This side mirror 200 includes many similar features with the side mirror described in FIGS. 2 to 4. These overlapping features will not be repeated. Further, the mirror housing 202 includes an indicator light 502 that is mounted on the side of the mirror housing 202. The indicator light 502 may go through multiple lighting states which are illustrated in FIG. 6. These multiple lighting states may indicate various operational states of the vehicle. Example lighting states of the indicator light 502 with their corresponding operational states of the vehicle are illustrated in FIG. 6.

In FIG. 6, a first lighting state 602 corresponds to when the charging port is open. The first lighting state 602 is illustrated as a white light. A second lighting state 604 corresponds to when the charging port is connected but the vehicle is not being charged. The second lighting state 604 is illustrated as a blue color. Multiple other lighting states 606/608/610 correspond to when the battery is charging and the battery is in various states of charge. The other lighting states 606/608/610 are illustrated as a red color, orange color, and cyan color respectively. While the lighting states are illustrated as various specific colors it is understood that these are just example colors and other color combinations may be used. Further, while different colors are used to signify different states, it is also contemplated that other lighting indicators may be used (e.g. different brightnesses, different portions of the light are illuminated). In some embodiments, the indicator light 502 may also be used as turn signals which may indicate to surrounding pedestrians and other drivers as to the direction the vehicle intends to go, thereby improving the safety and functionality of the vehicle.

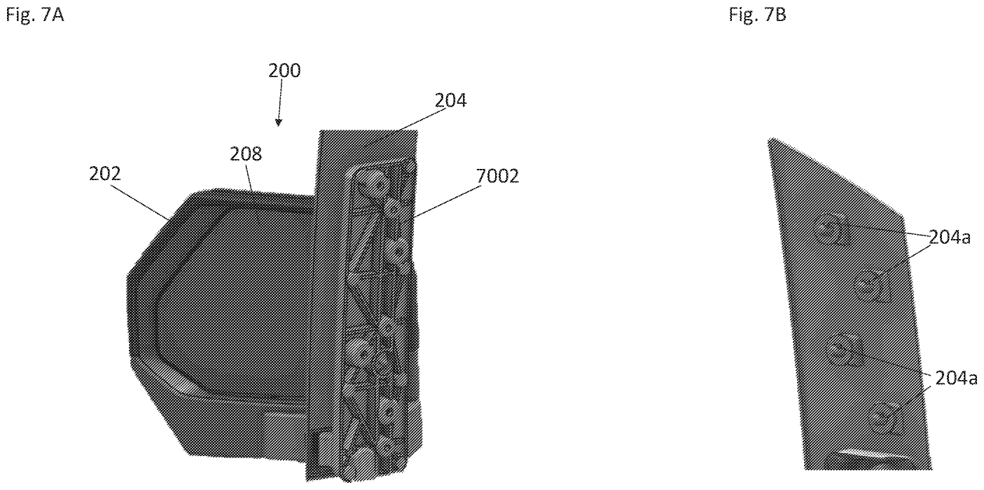

In accordance with some embodiments the side view mirror 200 may be mounted within the A-pillar of the vehicle, as illustrate in FIGS. 4A, 4B, and 5C-5F. In some embodiments, like those illustrated in FIGS. 7A and 7B, the elongated side pillar 204 may be implemented with multiple locator pins 204a which may fit into a mounting bracket 7002 by snap fit. The mounting bracket 7002 may be installed within the A-pillar of the vehicle. In some embodiments, the mounting bracket 7002 may be omitted and the elongated side pillar 204 may be directly mounted to the A-pillar through fasteners such as screws or bolts or through a glue or epoxy.

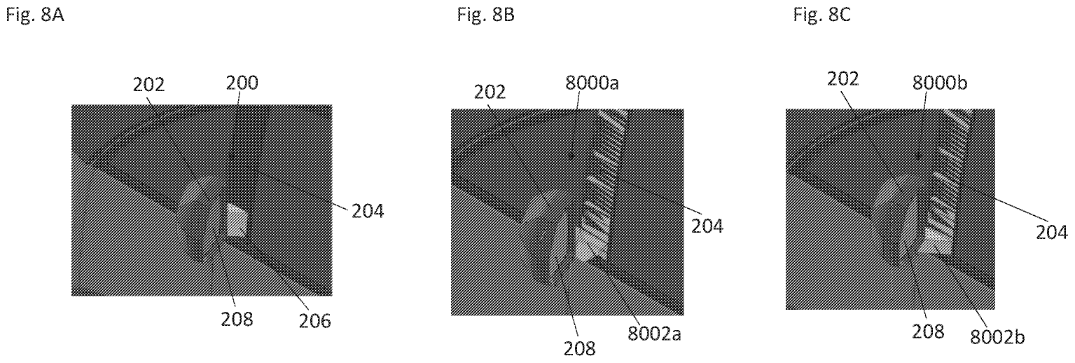

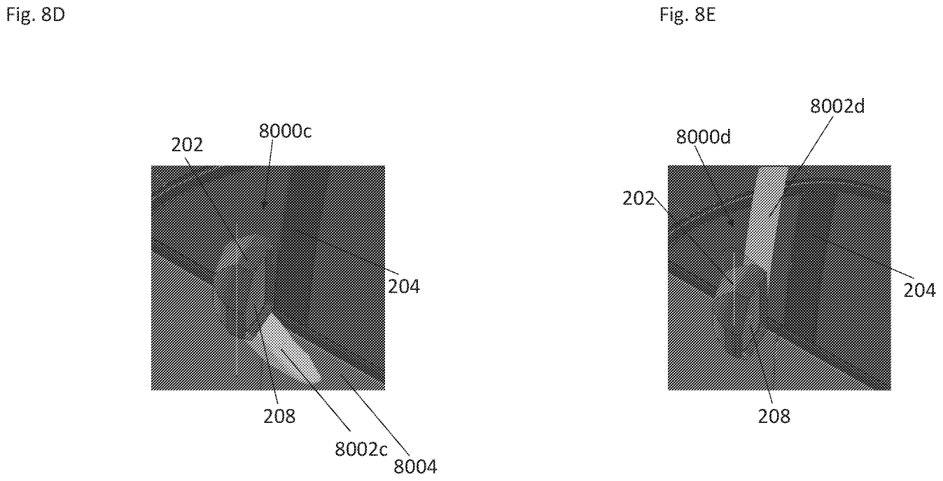

FIGS. 8A to 8E illustrate various embodiments of side mirrors mounted to a vehicle. All of the embodiments illustrated in FIGS. 8A to 8E include the mirror housing 202 with the mirror 208 described in connection with the FIGS. 2A and 2B. FIG. 8A is the side view mirror 200 including the mounting portion 206 described in connection with FIGS. 2A and 2B. However, FIGS. 8B to 8E illustrate various other side view mirror configurations with various other mounting portions. FIG. 8B illustrates a side view mirror 8000a with a mounting portion 8002a which protrudes out laterally of the elongated side pillar 204 and then extends towards the front of the vehicle. FIG. 8C illustrates a side view mirror 8000b with a mounting portion 8002b with a comparatively slimmer (less thick) design than the mounting portion 206 of FIG. 8A. FIG. 8D illustrates a side view mirror 8000c with a mounting portion 8002b designed to connect to the door 8004 of the vehicle rather than connect to an elongated side pillar 8002d. FIG. 8E illustrates a side view mirror 8000d with a mounting portion 8002d designed to connect to the roof of the vehicle rather than connect to an elongated side pillar 204. As described in connection with FIGS. 4A and 4B, these side view mirrors 8000a/8000b/8000c/8000d are designed in order to be implemented with the vehicle in order to meet or exceed the regulations. In some embodiments, the side view mirrors 8000a/8000b/8000c/8000d may be mounted in such a manner that the angle between the line of sight between the driver of the vehicle and the centroid of the mirror 208 and the vertical longitudinal plane of the vehicle are approximately less than or equal 54.5°.

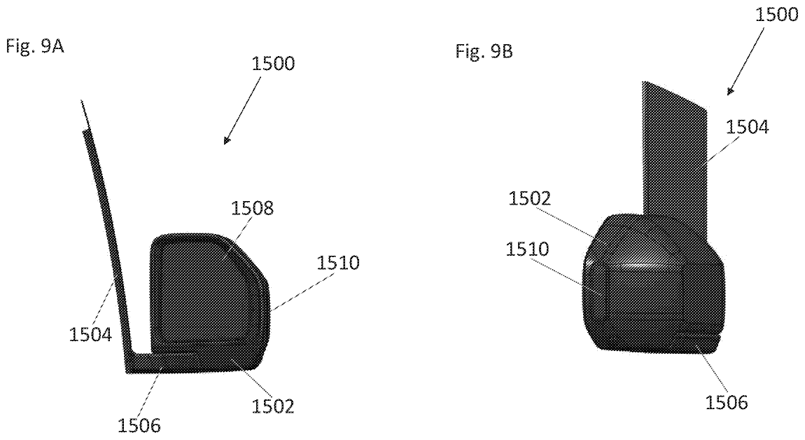

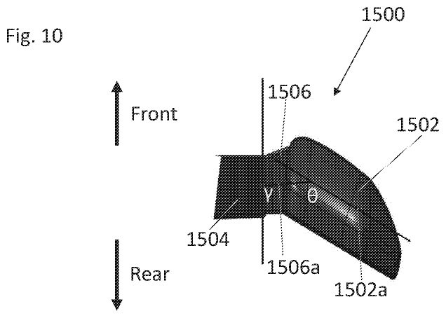

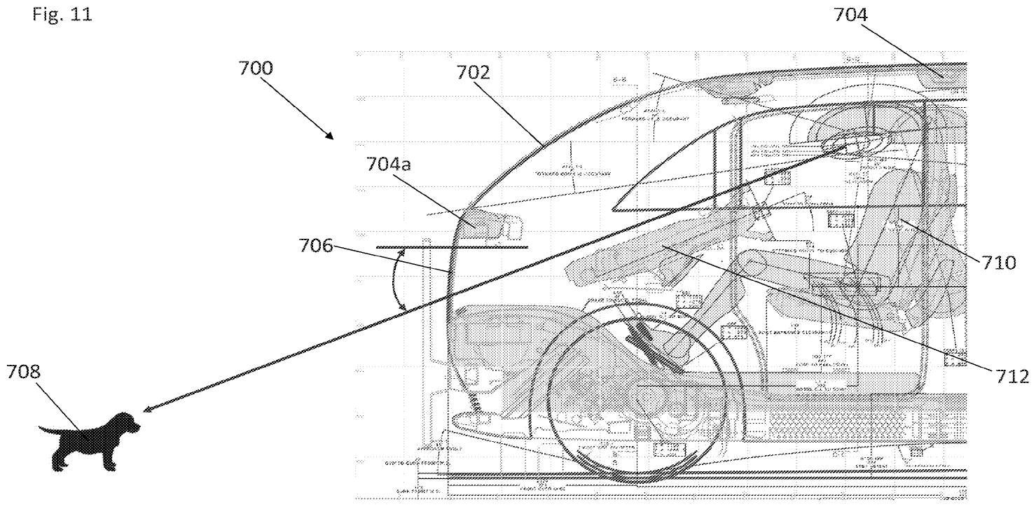

FIGS. 9A and 9B illustrate various perspective views of a side view mirror 1500. This side view mirror 1500 may be mounted on the passenger side of the vehicle whereas the side view mirror 200 discussed in connection with FIGS. 2 to 4 may be mounted to the driver side of the vehicle. The side view mirror 1500 includes a mounting portion 1506 and a mirror housing 1502. The mounting portion 1506 may be attached to an elongated side pillar 1504 which attaches to the vehicle with specifically designed mounting brackets and mounting points such that the mirror is fully supported and allows for the implementation of all adjustments within the specification above. Additionally, some embodiments may allow for the configuration of additional technological features which may be incorporated into the side view mirror through the mounting bracket. The mirror housing 1502 supports a mirror.

As illustrated, the side view mirror 1500 may include an indicator light 1510 which may go through various lighting states. For example, the indicator light 1510 may act in the functionality described in connection with FIG. 6. The different functionality may be divided between the indicator light 1510 on the side view mirror 1500 mounting on the passenger side of the vehicle and the indicator light 502 on the side view mirror 200 mounting on the driver side of the vehicle. For example, indicator light 1510 may indicate that the charger has been plugged into the charger port whereas indicator light 502 may indicate the charging state of the vehicle. Further indicator light 1510 may act as a turn signal which may indicate to surrounding pedestrian and other drivers as to the direction the vehicle intends to go, thereby improving the safety and functionality of the vehicle.

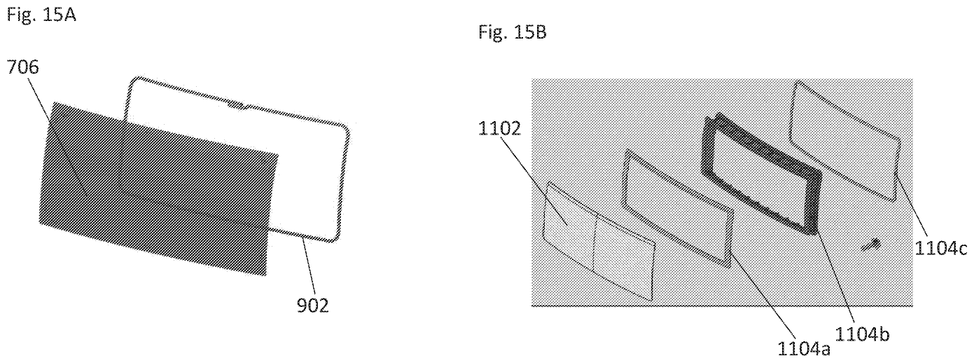

FIG. 10 illustrates a marked up top down view of the side view mirror 1500 described in connection with FIGS. 15A and 15B. As illustrated, the mounting portion 1506 includes a mounting portion extending direction 1506a. The extending direction may create an angle γ with the vertical longitudinal plane 302 of the vehicle. In some embodiments, the angle γ may be 90° or more. Further, the mirror housing 1502 may include a mirror housing extending direction 1502a. The mirror housing extending direction 1502a and the mounting portion extending direction 1506a may form an angle θ. In some embodiments, the angle θ may be 150° or less. The side view mirror 1500 mounting on the passenger side of the vehicle is not in the same configuration as the side view mirror 200 of the driver side of the vehicle. Thus these side view mirrors 200, 1500 are not symmetrical.

In accordance with many embodiments vehicles may be incorporated with a street view window that is positioned near the front of the vehicle. Turning now to the drawings, FIG. 11 illustrates schematic cross sectional view of an exemplary implementation of a vehicle 700. The vehicle includes a front end and a rear end. FIG. 11 illustrates the front end of the vehicle 700 which includes a vehicle body 704. The vehicle body 704 includes a horizontally extending middle portion 704a. On top of the horizontally extending middle portion 704a is a windshield 702. On the bottom of the middle portion 704a is an exemplary embodiment of a street view window 706. The driver 710 is positioned such that there is a clear line of sight over the steering column 712 out the street view window 702.

In traditional vehicles, a long hood/bonnet affects the ability of driver to judge objects in front of the vehicle. The inability to judge or view the objects in front of a vehicle can affect a driver's reaction time for stopping the vehicle before hitting the object. Accordingly, a window that allows a driver to see in front of a vehicle can improve the driver's ability to react faster to objects in front of a vehicle. Embodiments of the street view window 706 can assist the driver in areas like garage parking with limited space, a parking spot with a high ramp which would otherwise affect the underbody of the vehicle and even a child or pet in front of the vehicle while pulling in and out of parking spaces/houses etc. As illustrated, a driver 710 can utilize the street view window 706 to see objects 708 (e.g. a child or pet) which would normally be concealed by the extended hood/bonnet in previous vehicles.

The vehicle 700 with the street view window 706 may not have front park assist sensors as it provides a more accurate view of the ground beneath the front of the vehicle. Such embodiments would allow for simplified production methods and reduced complexity of vehicle control algorithms in safety and control of the vehicle. Some embodiments could implement both the forward assist sensors and the street view mirror 706 to allow for additional redundancies in the overall safety system.

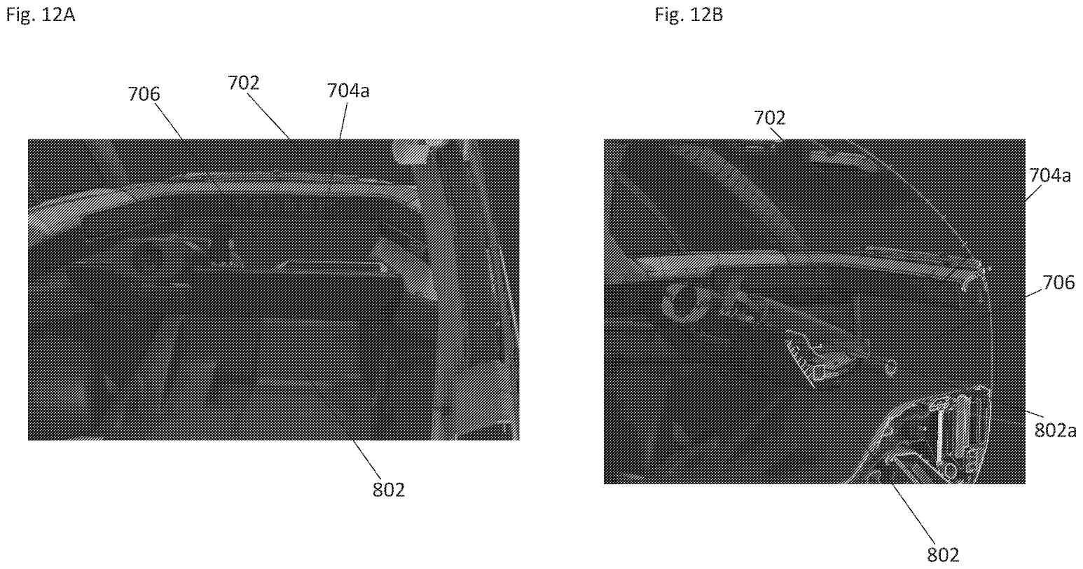

FIGS. 12A and 12B illustrate various additional views of the vehicle 700. As illustrated, the vehicle 700 may include various interior components 802 such as seats and a steering column. The interior components 802 may be positioned such that the drive has an unobstructed view of the ground through the street view window 706. In some embodiments, a steering column 802a may be positioned closer to the floor than in traditional vehicles to increase the driver's view of the ground through the street view window 706. The steering column 802a allows the driver to steer the vehicle through drive-by-wire which allows the front compartment to be absent of steering components. Further, drivetrain components such as the electric motor and the transmission are placed beneath the body of the vehicle and not in the front compartment of the vehicle. Advantageously, moving components that would otherwise be placed in the front compartment of the vehicle allows the view at the bottom portion of the front end of the vehicle to be relatively unobstructed and thus enables the placement of the street view window 706 which increases the driver's visibility of the ground beneath the front of the vehicle.

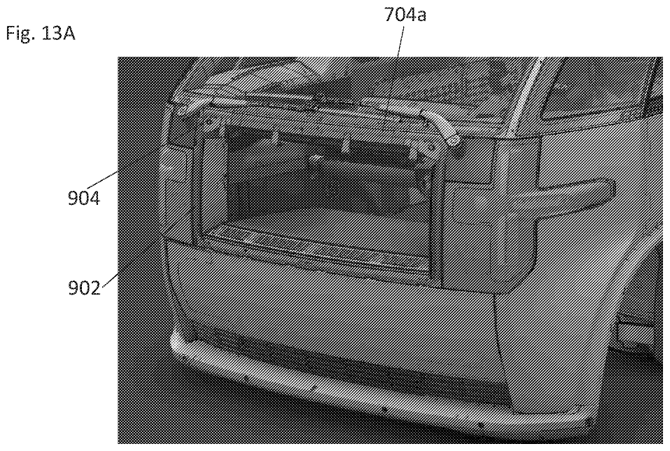

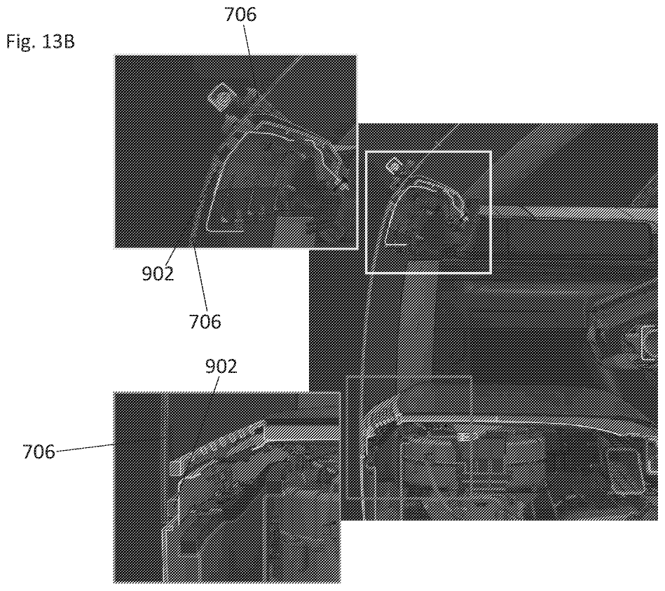

FIG. 13A is a perspective view of the vehicle 700. FIG. 13B illustrates a cross sectional view of the vehicle 700. The vehicle 700 may include a gasket 902 which is positioned in proximity to the perimeter of the street view window 706. When the street view window 706 is mounted to the vehicle 700, the gasket 902 makes direct contact with the street view window 706. The gasket 902 may be made out of a pliable material which molds to the street view window 706 and keeps moisture out of the cabin of the vehicle 700. There may be holes 904 positioned in the middle portion 704a which are capable of accepting fasteners which may hold in the street view window 706.

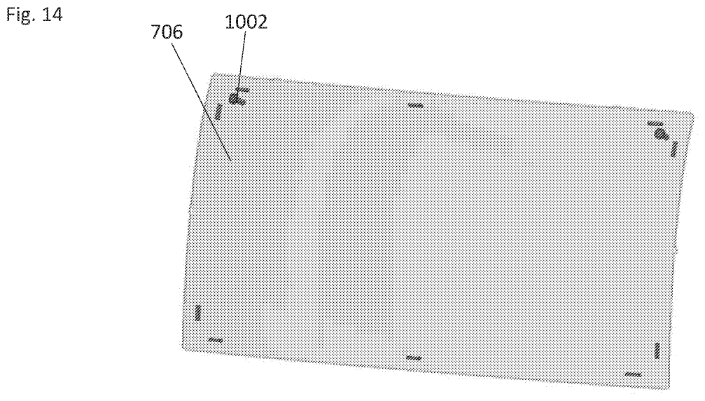

FIG. 14 is a perspective view of the street view window 706 when not mounted within the vehicle 700. Fasteners 1002 may go through the outside of the street view window 706 and attach to the holes 904 within the middle portion 704a illustrated in FIG. 13A. While two fasteners 1002 are illustrated, there may be more fasteners which fix the street view window 706 to the body 704. Alternatively, the street view window 706 may be mounted to the body 704 other methods such as glue, epoxy, pressure fit, or snap fittings.

FIG. 15A illustrates the street view window 706 along with the gasket 902. As illustrated above in FIGS. 11 to 14. FIG. 15B illustrates an alternative implementation of the street view window 1102 which includes various intermediate members 1104a, 1104b, 1104c. The intermediate members 1104a, 1104b, 1104c may include a subframe 1104b that may be made up of several components and/or sealing features to allow for the secured installation to the body 704. In some embodiments, the subframe 1104b for the street view mirror would collapse in the event of a frontal impact and allow some form of energy absorption, thus allowing the street view window 1102 to remain intact. This would be beneficial during contact between a pedestrian and the vehicle so as not to have the glass of the window injure the pedestrian.

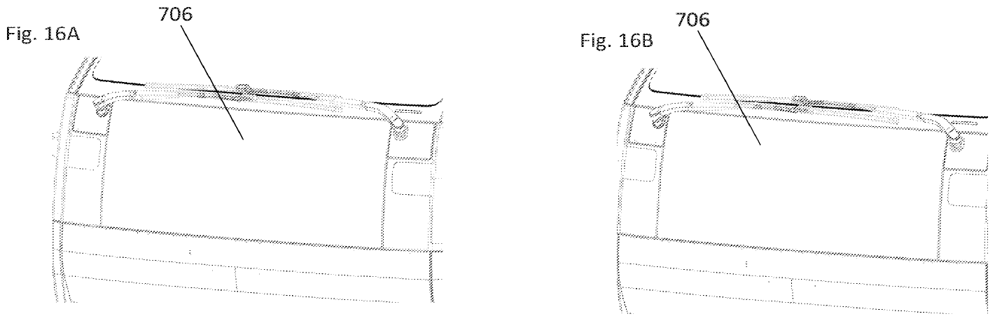

FIGS. 16A and 16B illustrates frontal views of various embodiments of the street view window 706 mounted on the vehicle 700. In FIGS. 16A and 16B, the street view window 706 is mounted directly to the frame in a Body in White (BIW) configuration. Thus the street view window 706 is mounted using a gasket 902 between a glass or clear view panel and the body 704. In some embodiments, the gasket 902 may be a urethane gasket 902.

### SUMMARY & DOCTRINE OF EQUIVALENTS

As can be inferred from the above discussion, the above-mentioned concepts can be implemented in a variety of arrangements in accordance with embodiments of the invention. Specifically, many embodiments include an electric vehicle positioned to take advantage of the potential extra space in such vehicles that do not require bulky internal combustion engines. Accordingly, many embodiments incorporate more forward positioned side view mirrors as well as open concept passenger compartments with street view windows. Achieving such functionality, according to embodiments, involves the implementation of special arrangements/designs between subsystems described above, and their equivalents.

Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A vehicle comprising:
an elongated side pillar extending vertically down a side front portion the vehicle; and
a side view mirror mounted on a bottom portion of the elongated side pillar,
wherein the side view mirror comprises:
a mounting portion extending horizontally from the elongated side pillar, wherein the mounting portion extends at an angle oblique with respect to a vertical longitudinal median plane of the vehicle, and wherein the mounting portion extends in a direction that is towards the front of the vehicle;
a mirror housing connected with the mounting portion, wherein the mirror housing extends in a direction towards the rear of the vehicle; and
a mirror supported by the mirror housing.

2. The vehicle of claim 1, further comprising a driver's seat positioned such that a driver has an eye box in the same vertical plane as a centroid of the mirror, and wherein an angle made by a line connecting the centroid of the mirror with a center of the eye box of the driver and another line extending through the center of the eye box of the driver and running parallel to the vertical longitudinal median plane of the vehicle is 55° or less.

3. The vehicle of claim 1, wherein the mirror housing extends from the mounting portion in a direction oblique with respect to the vertical longitudinal median plane of the vehicle.

4. The vehicle of claim 1, wherein the vertical longitudinal median plane is parallel to the extending direction of the vehicle.

5. The vehicle of claim 1, wherein the mirror and the mirror housing extend in substantially the same direction.

6. The vehicle of claim 1, wherein the mirror housing comprises an indicator of current range of the vehicle.

7. The vehicle of claim 6, wherein the indicator of current range of the vehicle comprises an indicator of charging state of the vehicle.

8. The vehicle of claim 7, wherein the indicator of charging state comprises a single indicator which changes colors based on various charging states of the vehicle.

9. The vehicle of claim 8, wherein the single indicator indicates whether a charging port door is opened or closed.

10. The vehicle of claim 9, wherein the single indicator indicates whether the charger is connected to the charging port.

11. The vehicle of claim 8, wherein the single indicator is configured to indicate an intended turning direction.

12. A vehicle comprising:
a body having a front end, a rear end and a middle section running transverse along the front end and across the front of the vehicle;
a steering wheel column;
a windshield secured to the middle section and disposed at the front end such that a user can visibly see through the windshield over the middle section at the horizontal eye line position;
a street view glass secured to the middle section, disposed at the front end, and positioned below the windshield such that the street view glass is below a user's horizontal eye line position, wherein the street view glass is configured to allow a user to see directly in front of the vehicle with an unobstructed view, and wherein the unobstructed view lies over the steering wheel column and under the middle section.

13. The vehicle of claim 12, wherein the street view glass is secured to the body with one or more fasteners.

14. The vehicle of claim 12, further comprising a gasket between the street view glass and the body.

15. The vehicle of claim 14, wherein the street view glass is connected to the middle portion through the gasket.

16. The vehicle of claim 12, wherein the windshield is connected to the middle portion through a windshield gasket.

17. The vehicle of claim 12, further comprising a subframe portion connected to the street view glass which is configured to absorb shock during a collision in order to keep the street view glass from breaking during a collision.

18. The vehicle of claim 1, further comprising drivetrain components located beneath a bottom of the body.

19. The vehicle of claim 19, wherein the drivetrain components comprise an electric motor and a transmission.

20. The vehicle of claim 1, wherein the steering wheel column is connected to steering components through drive-by-wire.
